(19) United States
(12) Patent Application Publication
(10) Pub. No.: US 2011/0029337 A1
(43) Pub. Date: Feb. 3, 2011

(54) PROVIDING A POLICY TOPOLOGY MODEL THAT INTERCONNECTS POLICIES AT DIFFERENT LAYERS

(76) Inventors: KAI LI, Beijing (CN); Gerald William Winsor, Cupertino, CA (US); Jishnu Mukerji, Short Hills, NJ (US); Joel Juden Fleck, II, Murray Hill, NJ (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/512,254

(22) Filed: Jul. 30, 2009

(51) Int. Cl. G06Q 10/00

(52) U.S. Cl. 705/7

(57) ABSTRACT

A policy topology model that relates policies at different layers associated with an enterprise is provided, where the layers include a higher-level business layer and at least a lower-level layer. The policy topology model includes a policy topology map of the policies and corresponding policy engines to implement the respective policies. A connection module of the policy topology model is used to interconnect the policies at the different layers and to associate multiple domains. The connection module under a particular condition also transforms at least one of the policies.

### BACKGROUND

Policy engines implement and execute policies, or services, that are defined by an enterprise that represent conditions or actions that an enterprise expects to occur or be executed when specific criteria are met. Policies can be defined for various aspects across the whole organizational structure of the enterprise. For example, one policy can be a pricing policy to define the price for a particular good or service. As another example, another policy may define the number of times a specific service may be invoked by a partner. Some policies deployed at different parts of the enterprise may be related, but it may be challenging to identify such relationships between the various policies.

### BRIEF DESCRIPTION OF THE DRAWINGS

Some embodiments of the invention are described with respect to the following figures:

FIG. 1 illustrates an exemplary architecture that includes a policy topology model that has a repository for policies at different layers of the enterprise, and a connection module that interconnects related policies, in accordance with an embodiment;

FIG. 2 illustrates concepts associated with a connection module according to an embodiment;

FIG. 3 is a flow diagram of a process according to an embodiment;

FIG. 4 is a flow diagram of an exemplary process performed by the connection module according to an embodiment;

FIG. 5 is a schematic diagram of tightly-coupled domains, according to an embodiment;

FIG. 6 is a schematic diagram of loosely-coupled domains, according to another embodiment;

FIG. 7 is a block diagram of a computing system that incorporates a policy model according to an embodiment.

### DETAILED DESCRIPTION

An enterprise (such as a business, telecommunications provider, educational organization, government agency, and so forth) can define a hierarchical structure that utilizes a “layered model” where different layers represent different levels of management services in the enterprise. For example, a hierarchical policy model can include a business layer (or business management layer), service layer (or service management layer), network layer (or network management layer), and element layer (or network management layer). The business layer represents the high-order entity layer (among the layers listed). As examples, the business layer can provide one or more of the following functions: billing, account management, administration, trend analysis, quality control, and/or any other functions related to the business aspects of the enterprise. The service layer performs functions for handling services in a network, where such functions can include, as examples, definition of services, administration of services, charging of services, and so forth. The network layer performs functions for distribution of network resources, including, as examples, configuration of a network, control of the network, supervision of the network, and so forth. The element layer contains functions for handling of individual network elements, including, as examples, alarm management, handling of information, performing data backup, and so forth.

In one embodiment, the layers discussed above are according to the Telecommunications Management Network protocol model, as provided by the International Telecommunication Union (ITU). However, in other embodiments, the various policy definition layers associated with an enterprise can be defined by other protocols, or can be implemented as proprietary layers. Generally, the various layers of an enterprise can include higher-level layers and lower-level layers, where the highest-level layer is a business layer to provide and expose high-order entity business services.

Policies can be specified, or associated with, each of the different layers and implement business goals of the enterprise. It is noted that the policies of the different layers are not stand-alone, singular artifacts. Rather, the policies of the different layers may be connected such that a policy encompasses higher-order and lower-order entities within different layers. For example, a policy in the business layer may be decomposed into policies at the service and lower-order layers that implement, or enforce, the business goal articulated in the policy definition in the business layer. In addition, policies at the business layer are implemented by further policies at lower layers, including the network layer and the element layer.

Traditionally, identifying how a business layer policy may be impacted by changes to, or creation of new policies in lower-order layers within the enterprise may be a challenging task, particularly in complex business environments that have multiple domains and that have a large number of components within each layer. Each component in a layer encapsulates and executes policies. Multiple domains can refer to different roles within an enterprise, such as an accounting domain, research and development domain, manufacturing domain, and so forth. In some cases, such as in manufacturing value chains, domains can span multiple enterprises, where each enterprise has different policies in a specific layer—and these “different” policies have to be aligned to ensure specific business conditions are executed correctly.

Generally, in a complex environment having multiple domains and multiple layers each with their own corresponding policies, it may be difficult for an enterprise to determine what impact a local, lower level policy change may have on a policies at a higher-level layer, or how a higher-order policy change may effect lower-order layer policies. In addition, in some cases, a high-level executive, or a line of business manager, who may be responsible for business strategies within an enterprise, may wish to have an understanding of policy model inter-connectivity across, and between, layers and/or the domains. However, even though this high-level personnel may be able to access high-level policies at the business layer, it may be difficult to obtain policies at lower-level layers that are related to, or impacted by, the high-level policies.

In accordance with some embodiments, a policy topology model is provided that relates policies at different layers associated with an enterprise. The policy topology model includes a policy topology map of the policies and the corresponding policy engines that implement the respective policies. A policy engine generally refers to any function, or system, that implements a policy in the enterprise. The function can be in the form of a software application, a collection of software applications, a script, and so forth.

The policy topology model according to some embodiments also includes a connection module that is used to interconnect the policies at the different layers. The connection module is also used to inter-relate, and/or transform, policies across multiple domains, since different policy engines may expect a policy defined in a specific format or construct. By extrapolating the different policies onto a common structure, or policy topology map, the relationships between interconnected policies spanning the different layers and across domains can be more easily understood.

Moreover, a simplified mechanism is provided by which the impact of a policy change at one layer on other policies at different layers and/or across domains can be understood. In this way, in response to a change of a policy at any one layer, corresponding changes, or impacts, to policies of other layers or in other domains can be determined based on the understanding of the relationships between the policies at the different layers. Moreover, a user such as a high-level executive or line of business manager can easily view existing policies in different layers and/or domains, and then manage, trace, and analyze such distributed policy modifications.

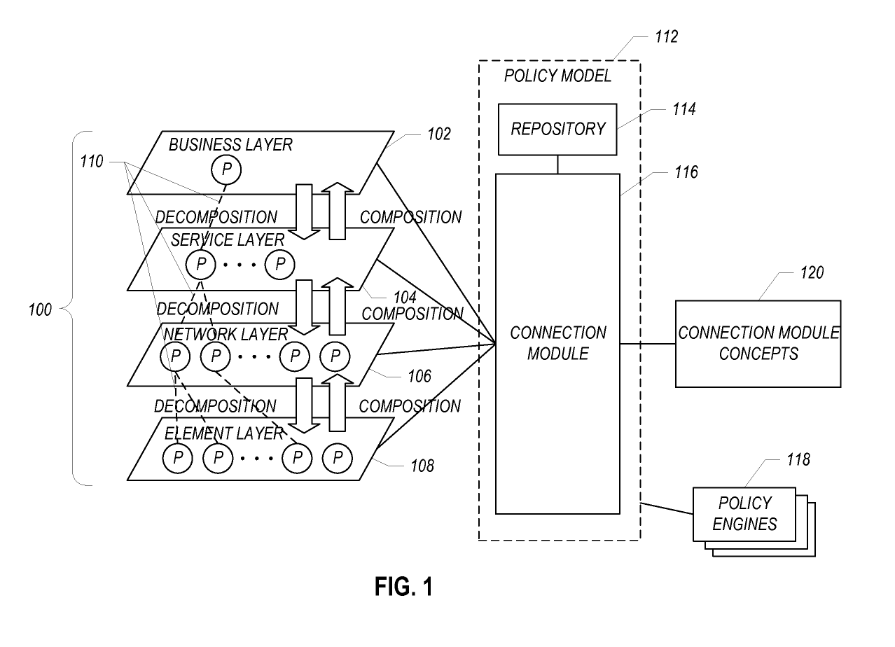

FIG. 1 shows a hierarchy 100 of layers associated with an enterprise, where the hierarchy 100 includes a business layer 102, a service layer 104, a network layer 106, and an element layer 108. FIG. 1 also shows various policies (represented by circles each containing a “P” inside the circle) and policy engines 118 associated with the layers. Dashed lines 110 represent relationships among a subset of the policies in the different layers.

In accordance with some embodiments, a distributed policy management and connection model (DPM-CM) 112 (more simply referred to as a “policy topology model”) is provided to relate the policies at the different layers 102, 104, 106, and 108 (and across domains, as discussed further below). The policy topology model 112 includes a policy repository 114 and a connection module 116. The policy repository 114 contains a policy topology map of all known policies in the layers, and identifiers to policy engines 118 that implement the corresponding policies. The connection module 116 establishes connectivity of policies in the layers 102, 104, 106, and 108 to the policy engines 118. The connection module 116 also defines interconnection attributes, “transforms,” between related policies in the different layers, such as the policies related by the dashed lines 110.

A policy at the business layer 102 can be decomposed downwards in the hierarchy 100 of layers across multiple layers to implement a particular business strategy or technical specification, which results in policy relationships between the layers and/or different domains. In the opposite direction, policies at lower-level layers are composed into policies at higher-order layers. FIG. 1 illustrates just a single domain. Embodiments involving multiple domains are discussed further below.

As defined by the dashed lines 110, a policy at the business layer 102 can be decomposed into a policy at the service layer 104, which can then be further decomposed into policies at the network layer 106, which can be decomposed into policies at the element layer 108. A policy relationship between layers can be defined by an inverted tree topology, for example. The inverted tree topology provides a hierarchical representation of policies in one layer that are related to policies in a lower-order layer. The inverted tree topology (or other representation of relationships among policies) can be maintained by the policy repository 114 of the policy topology model 112.

Note that the policy repository 114 can also map policies between domains. For example, a policy in the service layer 104 of one domain can be mapped to a policy of a service layer in another domain (discussed further below). During operation, the connection module 116 is able to access the policy repository 114.

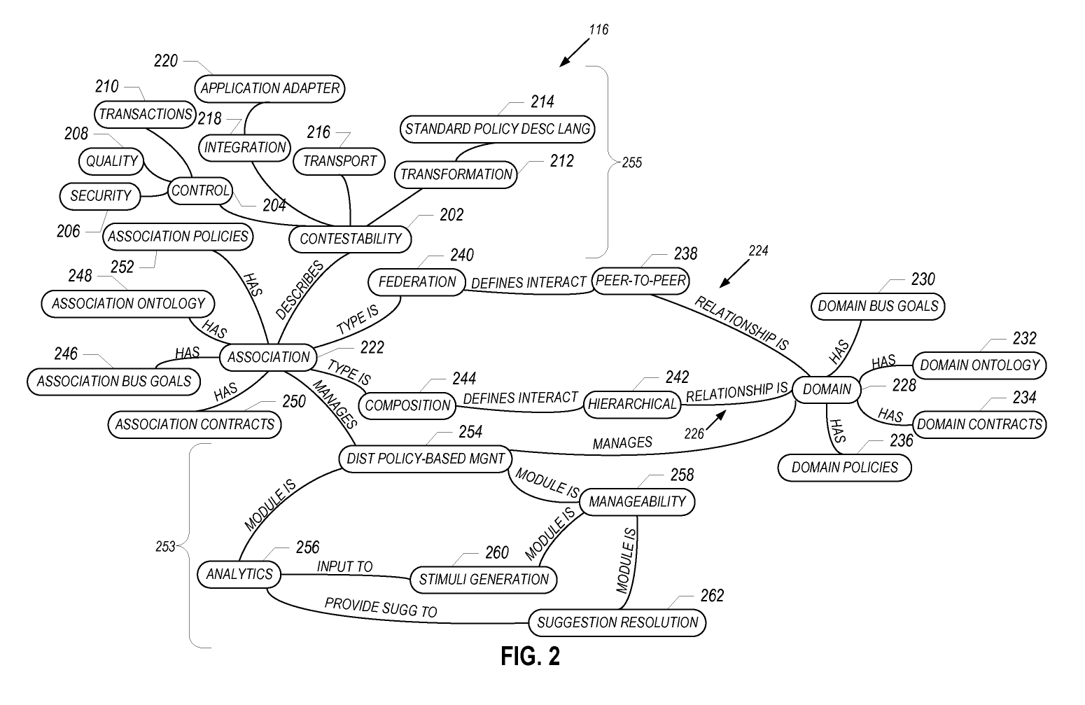

The connection module 116 is further associated with various concepts 120, which are described in further detail in connection with FIG. 2. FIG. 2 is a graph including nodes that represent corresponding concepts, and links between the nodes to represent relationships among the concepts.

In an upper portion of the graph in FIG. 2, a collection 200 of nodes is linked to a Connectability node 202. The Connectability node 202 represents the technologies used to implement connectivity between layers. The Connectability node 202 is linked to a Control node 204 that implements various control functions associated with the connection module 114. For example, the Control node 204 can implement security tasks 206, quality control tasks 208, and transaction control tasks 210.

The Connectability node 202 also is linked to a Transformation node 212 that is able to transform a policy description in a first language to a policy description in a standard language (214). The policy description in the first language is retrieved through an application adapter (220) that is coupled through an Integration node 218.

The Connectability node 202 is also linked to a Transport node 216, which provides transport services (for transmission of messages and other information, for example).

The Connectability node 202 is further linked to an Association node 222, which defines various associations, including associations among domains and among layers. The Association node 222 can be linked through a peer-to-peer branch 224 or a hierarchical branch 226 with a Domain node 228, which is used to represent domains. The domain node 228 is linked to the following nodes: Domain Business Goals 230 (which define the business goals of each domain), a Domain Ontology 232 (that defines the ontology of the domain), Domain Contracts 234 (which define the contracts of the domain), and Domain Policies 236 (which define the policies of the domain).

Domains can be related based on a peer-to-peer relationship, such as between a customer and provider (whether in the same enterprise or across enterprises). The peer-to-peer relationship is represented across the peer-to-peer branch 224 that includes a Peer-to-Peer node 238 and a Federation node 240. The relationship between peer-to-peer domains is a relatively loose relationship, and specifies that goals or policies of the domains should be compatible.

Domains can also have hierarchical relationships, as represented by the hierarchical branch 226 that includes a Hierarchical node 242 and a Composition node 244. Two domains can have a hierarchical relationship when one domain is part of another domain. In this case, a stricter relationship is defined between the hierarchical domains, as represented by the Composition node 244, which specifies that the business goals/policies of one domain should be composed of the goals/policies of the other domain.

Whereas nodes 230, 232, 234, and 236 represent the business goals, ontology, contracts, and policies within a domain, it is noted that there can be associations of business goals, ontology, contracts, and policies between domains, which are represented by the following nodes, respectively: Association Business Goals 246, Association Ontology 248, Association Contracts 250, and Association Policies 252.

The lower portion of the graph of FIG. 2 illustrates another collection 253 of nodes that are linked to a Distributed Policy-Based Management node 254. The Distributed Policy-Based Management node 254 is linked to an Analytics node 256 that performs analysis of various issues, such as detected problems. The Analytics node 256 is able to cause generation of possible changes to be made to address the detected issues, where generation of possible changes is represented by a Stimuli Generation node 260. The Stimuli Generation node 260 is linked to a Manageability node 258, which represents various management tasks.

The Analytics node 256 is also linked to a Suggestion Resolution node 262, which represents the resolution decided upon by the Analytics node 256 for addressing a particular issue. The resolution is provided to the Manageability node 258 for implementation.

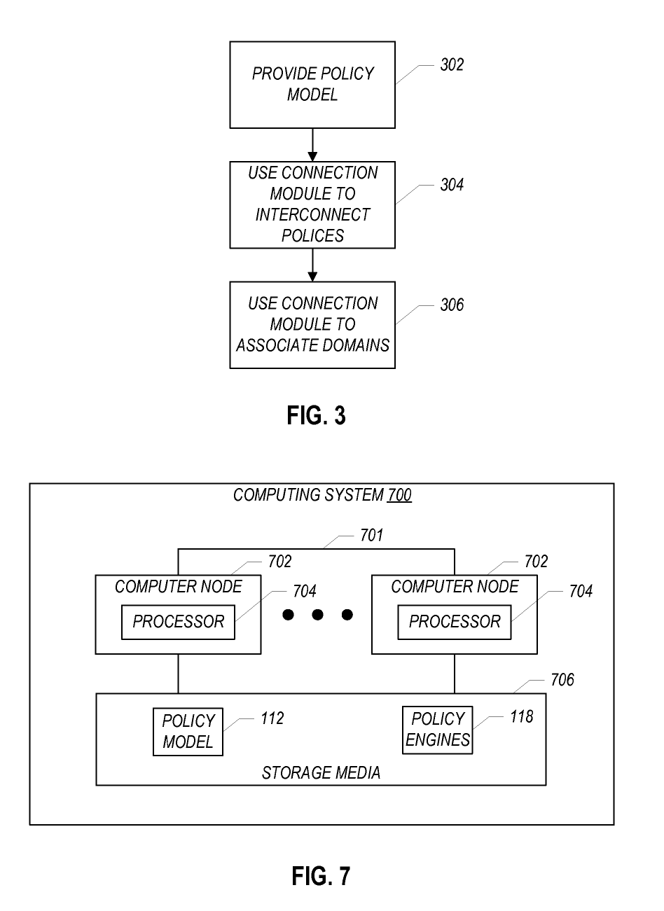

FIG. 3 illustrates a general flow diagram of a process according to an embodiment. A policy topology model is provided (at 302), where the policy topology model relates policies at different layers associated with the enterprise. A policy topology model includes a policy repository that stores a policy topology map of policies and corresponding policy engines used to implement the respective policies.

The connection module 116 of the policy topology model is used (at 304) to interconnect the policies at the different layers based on the topology map in the policy repository 114, as well as to perform other tasks as discussed above (including applying transforms to transform at least one of the policies to a format expected by a policy engine). Note that the transform is applied under particular conditions, such as when the format of a policy is not in the expected format. In addition, the connection module 116 can be used to associate (at 306) different domains, such as associating business goals, policies, ontologies, and contracts of the different domains (as discussed above in connection with FIG. 2).

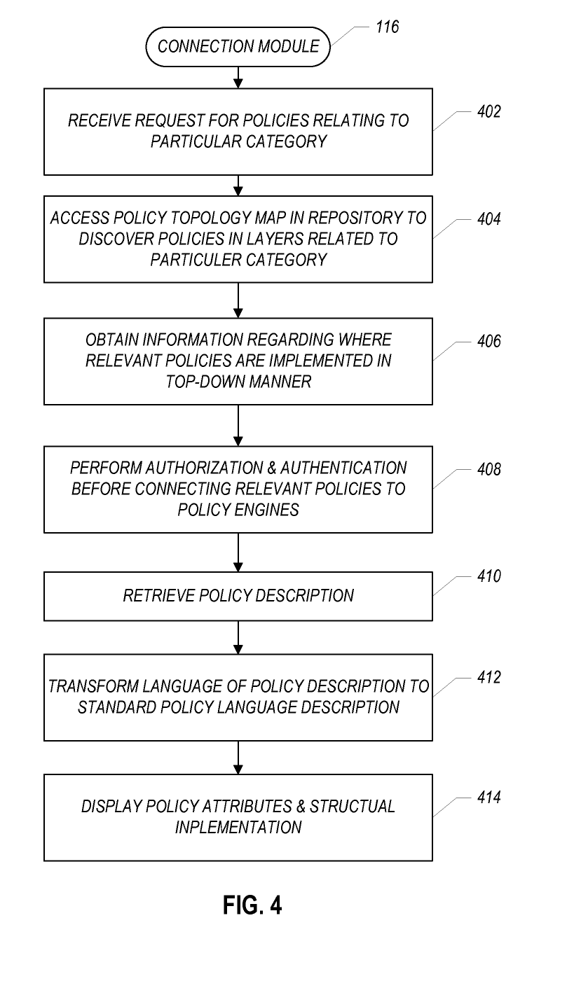

FIG. 4 is a flow diagram of tasks performed by the connection module 116 according to an embodiment. The connection module 116 receives (at 402) a request for policies relating to a particular category. For example, a request may be received from a line of business manager or a high-level executive for the pricing policy associated with the enterprise that defines how prices are assigned to a particular good or service.

The connection module 116, in response to the request, accesses (at 404) the policy topology map in the repository 114 to discover policies in the various layers that are related to the particular category. For example, if the request is for the pricing policy, the connection module 116 attempts to find all policies in the different layers that are related to pricing.

The connection module 116 then obtains (at 406) information regarding where the relevant policies are implemented in a top-down manner through the hierarchy 100 of layers.

The connection module 116 can perform (at 408) authorization and authentication tasks before connecting relevant policies to respective policy engines. The authorization and authentication tasks are performed to ensure that the user requesting access in fact has the authority to access the requested information.

A policy description is then retrieved (at 410), such as using the application adapter represented by node 220 in FIG. 2. The policy description provides a description of the policies defined at the various layers that relate to the particular category that is the subject of the receiving request.

The language of the policy description is transformed (at 412) to a standard policy language description, using a transformation function represented by the Transformation node 212 in FIG. 2.

The policy attributes and structural implementation information can then be displayed (at 414) to the requesting user.

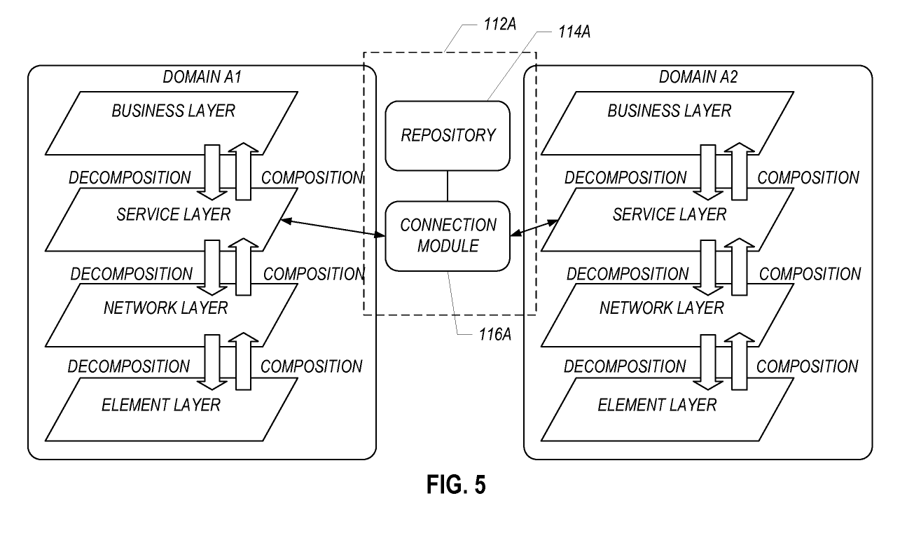

FIG. 5 illustrates a multi-domain implementation, including domain A1 and domain A2. The implementation of FIG. 5 is a tightly-coupled implementation, where a policy model 112A is used to relate policies in different layers in the two domains. Each of the domains A1 and A2 includes respective layers that can be associated with corresponding policies. As shown in the example of FIG. 5, the policy model 112A includes a repository 114A and a connection module 116A, similar to the repository 114 and connection module 116 shown in FIG. 1, except that the policy model 112A further contains information relating policies in different domains. In the example of FIG. 5, policies in the service layer 104 of domain A1 can be interconnected to a policy in the service layer 104 of domain A2. The connection module 116A is able to transport policy structures between the two different domains, and can address the situation where the implementation method may differ between the domains. Also, the connection module 116A can monitor interactions across the domains.

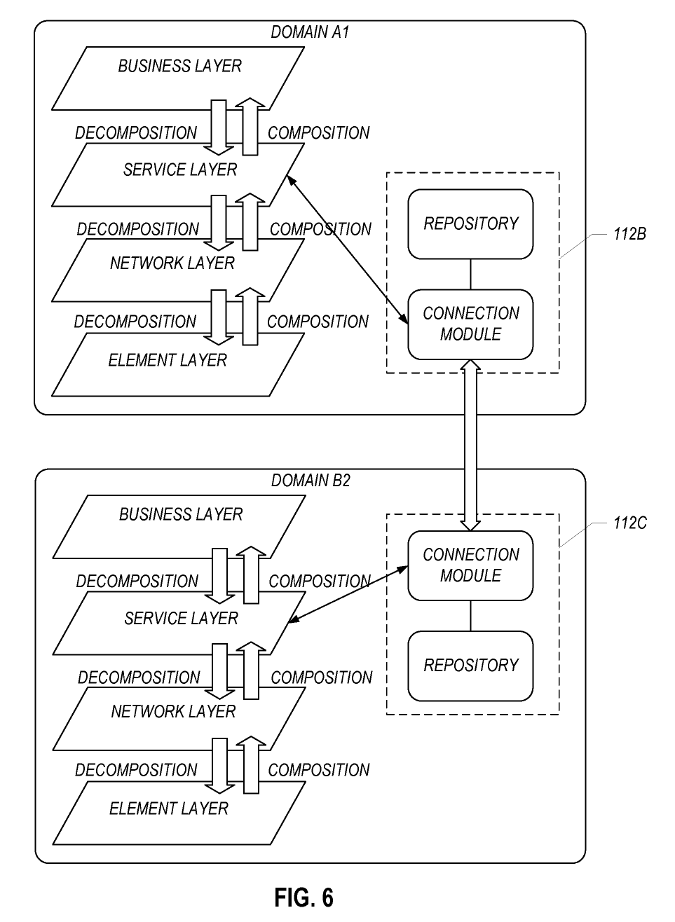

FIG. 6 shows two domains A1 and B2 that contain respective hierarchies of layers. However, instead of using one policy model (such as policy model 112A in FIG. 5), two different policy models 112B and 112C are employed in the respective domains A1 and B2. In this implementation, the policy model is replicated and interconnected across domains. The repository in one domain includes relationships with policies contained in another domain. The connection module in one domain interconnects with its cross-domain connection module, and this connection module topology is maintained in both repositories of the policy models 112B and 112C.

A transport policy between different domain layers can be instantiated—for example, the service layer of domain B2 can request the policy from the connection module of domain B2, and in response, the connection module of domain B2 can discover the source domain and request the policy from the connection module in domain A1. In response, the connection module in domain A1 locates the source policy and returns the policy back to domain B2.

An exemplary computing system 700 in which some embodiments can be incorporated is depicted in FIG. 7. The computing system 700 can be a distributed computing system having multiple computer nodes 702. Each computer node 702 has a processor 704, which can represent one or multiple central processing units (CPUs). The computer nodes 702 are connected to a network 701.

The computing system 700 also includes storage media 706, which can be distributed storage media connected to corresponding computer nodes 702. The storage media 706 contains one or more policy models 112 and policy engines 118. The policy engines 118 can be executed on the computer nodes 702.

Functionalities according to some embodiments as described above can be implemented with software. Instructions of such software can be loaded for execution on a processor (such as processors 704). A processor includes microprocessors, microcontrollers, processor modules or subsystems (including one or more microprocessors or microcontrollers), or other control or computing devices.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method comprising:
providing a policy topology model that relates policies at different layers associated with an enterprise, wherein the layers include a higher-level business layer and at least a lower-level layer, and wherein the policy topology model includes a policy topology map of the policies and corresponding policy engines to implement the respective policies; and
using, by a computing system, a connection module of the policy topology model to interconnect the policies at the different layers and to associate multiple domains, and wherein the connection module under a particular condition also transforms at least one of the policies.

2. The method of claim 1, wherein a particular one of the policies at the lower-level layer is decomposed from a second one of the policies at the business layer, the method further comprising using the connection module to discover the particular policy and the second policy as being related.

3. The method of claim 2, wherein the lower-level layer is a second layer, and wherein the layers further include a third layer below the second layer, and wherein the third layer has a third policy that is related to the particular policy and the second policy,
the method further comprising using the connection module to discover the particular policy, second policy, and third policy as being related in a top-down manner.

4. The method of claim 3, wherein the second layer is a service layer, and the third layer is a network layer.

5. The method of claim 4, wherein the layers further include an element layer that represents elements in the network layer, wherein the element layer further includes another policy interconnected to the third policy by the connection module.

6. The method of claim 1, further comprising:
using the connection module to perform authorization and authentication prior to connecting policies to the policy engines.

7. The method of claim 1, further comprising:
receiving, by the connection module, a request to review policies related to a particular category;
obtaining information regarding the policies for the different layers related to the category by the connection module in response to the request; and
transforming the obtained information into a common format.

8. The method of claim 1, wherein the layers are part of a first one of the domains, and wherein a second one of the domains includes layers including a business layer and a lower-level layer, the method further comprising using the connection module to relate at least one policy in the first domain to at least another policy in the second domain.

9. The method of claim 8, wherein associating the first and second domains further comprises associating one or more of business goals, ontologies, and contracts.

10. The method of claim 1, wherein associating the domains further comprises establishing a peer-to-peer association between the domains.

11. The method of claim 1, wherein associating the domains further comprises establishing a hierarchical association between the domains.

12. The method of claim 1, wherein the layers are part of a first one of the domains, wherein the connection module is part of the first domain, wherein a second one of the domains includes layers including a business layer and at least one lower-level layer that include policies, and wherein the second domain further includes another connection module to interconnect the policies of the second domain.

13. A computing system comprising:
storage media to store a repository of a policy topology model regarding policies maintained at different layers in a hierarchy of layers associated with an enterprise, wherein the layers include a business layer and a lower-level layer; and
one or more processors to execute a connection module of the policy topology model to discover related policies in the different layers and to associate characteristics of multiple domains.

14. The computing system of claim 13, wherein each of the domains includes a respective hierarchy of layers, and wherein the connection module is configured to associate policies across layers in the domains.

15. The computing system of claim 13, wherein the characteristics of the multiple domains that are associated include one or more of policies of the respective domains, business goals of the respective domains, contracts of the respective domains, and ontologies of the respective domains.

16. An article comprising at least one computer-readable storage medium containing instructions that upon execution cause a computing system to:
provide a policy topology model that relates policies at different layers associated with an enterprise, wherein the layers include a higher-level business layer and at least a lower-level layer, wherein the policy topology model includes a policy topology map of the policies and corresponding policy engines to implement the respective policies; and
use a connection module of the policy topology model to interconnect the policies at the different layers and to associate multiple domains; and
transform, by the connection module under a particular condition, at least one of the policies.

17. The article of claim 16, wherein the layers are part of a first one of the domains, and wherein a second one of the domains includes layers including a business layer and a lower-level layer, the instructions upon execution causing the computing system to further use the connection module to relate at least one policy in the first domain to at least another policy in the second domain.

18. The article of claim 17, wherein associating the first and second domains comprises associating one or more of business goals, ontologies, and contracts.

19. The article of claim 17, wherein transforming the at least one policy comprises transforming the at least one policy to a specific format.
